(19) United States
(12) Patent Application Publication
(10) Pub. No.: US 2022/0398947 A1
(43) Pub. Date: Dec. 15, 2022

(54) DYNAMICALLY OPERATED SIGN

(71) Applicant: DeLorean, LLC, Bloomfield, MI (US)

(72) Inventor: Jack Z. DeLorean, Bloomfield, MI (US)

(21) Appl. No.: 17/832,172

(22) Filed: Jun. 3, 2022

Related U.S. Application Data
(60) Provisional application No. 63/197,602, filed on Jun. 7, 2021.

(51) Int. Cl. G09F 7/22; G09F 19/22

(52) U.S. Cl. CPC G09F 7/22; G09F 19/22; G09F 2027/001

(57) ABSTRACT

Signs according to this application are be configured to output content on a display for viewing by bystanders, occupants of vehicles, and so forth. In some instances, the sign may be oriented to output content within a certain range of view angles relative to the sign. Additionally, content output by the sign may be based at least in part on characteristics of the environment in which the sign is located, a speed of the vehicle, a number of viewers within the viewing range of the sign, weather conditions, and so forth. Sensor(s) may sense conditions within the environment for controlling an operation of the sign. While examples are described herein in which signs include electronic displays, in some examples, signs according to this disclosure can be non-electronic (e.g., plastic, wood, paper, and/or metal signs with content painted, printed, or otherwise applied thereto).

### RELATED APPLICATIONS

This patent application claims priority to U.S. Provisional Patent Application Ser. No. 63/197,602, which was filed Jun. 7, 2021, the entire contents of which are incorporated herein by reference.

### BACKGROUND

Today's highly saturated television market makes it increasingly difficult for advertisers or businesses to reach their audiences in a cost-effective manner. The advent of cable, satellite television, and hundreds of channels, as well as the fast-growing popularity of digital video recorders, has induced merchants to spend more on advertising. However, the proliferation of media has lessened the number of viewers per medium and per advertising dollar. Studies show up to 40 percent of advertising is wasted and TV advertising's return on investment yields only 1 to 4 percent. Newspapers are in decline as well, as their advertising base dissipates with the digital age. Accordingly, there is a need for a cost-effective advertising solution.

### BRIEF DESCRIPTION OF THE DRAWINGS

The Detailed Description is set forth with reference to the accompanying figures. In the figures, the left-most digit(s) of a reference number identifies the figure in which the reference number first appears. The same reference numbers in different figures indicate similar or identical items. The systems and devices depicted in the accompanying drawings are not to scale and components within the drawings may be depicted not to scale with each other.

FIG. 1 illustrates an example environment in which a variety of signs display content, according to an embodiment of the present disclosure. In some instances, the signs may communicatively couple to a remote system which, in some instances, controls an operation of the sign(s), such as content to displayed on the sign(s).

FIG. 2 illustrates an example environment in which signs located in different geographical regions are controlled to display different content, according to an embodiment of the present disclosure.

FIGS. 3A and 3B illustrate example components of the signs of FIG. 1, according to an embodiment of the present disclosure.

FIG. 4 illustrates an example environment including an unmanned aerial vehicle (UAV) for determining characteristics of the environment and/or controlling an operation of one or more signs, according to an embodiment of the present disclosure.

FIG. 5 illustrates an example environment for controlling an operation of multiple signs, according to an embodiment of the present disclosure.

FIG. 6 illustrates an example process for controlling an operation of one or more signs within an environment, according to an embodiment of the present disclosure.

FIG. 7 illustrates an example process for determining routes of vehicles to which signs couple, according to an embodiment of the present disclosure.

FIG. 8 illustrates an example process for controlling an operation of a sign based on detecting autonomous vehicle(s) with a proximity of the sign, according to an embodiment of the present disclosure.

FIG. 9 illustrates an example process for controlling an operation of a sign, based on characteristics of a vehicle to which the sign couples, according to an embodiment of the present disclosure.

FIG. 10 illustrates an example process for determining loads applied to a sign for controlling an operation of the sign, according to an embodiment of the present disclosure.

FIG. 11 illustrates an example process for determining a presence of pedestrians within a proximity of a sign and controlling an operation of the sign based on determining the presence of the pedestrians, according to an embodiment of the present disclosure.

FIG. 12 illustrates example computing components of a remote system and a sign, according to an embodiment of the present disclosure.

### DETAILED DESCRIPTION

The present disclosure is directed, at least in part, to techniques for controlling an operation of a sign. In some instances, the sign may be stationary (e.g., disposed on a building, frame, gantry, pole, or other stationary support structure) or mobile (e.g., disposed on cars, buses, trailers, trains, aircraft, water craft, etc.). In some instances, an environment may include any number of disparate signs, whether stationary or moveable, located or positioned throughout the environment. Example signs according to this application can be configured to output content on a display for viewing by bystanders, occupants of vehicles, and so forth. In some instances, the sign may be oriented to output content within a certain range of view angles relative to the sign. Additionally, in some instances, the content output by the sign may be based at least in part on characteristics of the environment in which the sign is located, a speed of the vehicle (e.g., in instances where the sign is movable), a number of viewers within the viewing range of the sign, weather conditions, and so forth. Sensor(s) of the sign, or as otherwise disposed about the environment, may sense conditions within the environment for controlling an operation of the sign. While examples are described herein in which signs include electronic displays, in some examples, signs according to this disclosure can be non-electronic (e.g., plastic, wood, paper, and/or metal signs with content painted, printed, or otherwise applied thereto).

In some instances, the sign(s) within the environment may be communicatively coupled to a remote system that fully or partially controls operation of the sign(s). For example, sign(s) located proximate to one another may be restricted from outputting similar, or like, content. Here, the remote system may determine whether sign(s) located proximate to each other are outputting similar content, and in response, may adjust content being output or determine routes for the signs. Similarly, in the case of mobile sign(s), vehicles that travel along similar or proximate route(s) may be restricted from outputting similar content. Controlling the sign(s) in this manner, or controlling the content displayed on the signs, may prevent repetitive content being presented, may maximize advertising opportunities, and/or may increase viewer experiences.

In some instances, the remote system may transmit content and/or instructions for how the content is to be displayed by the sign. The content and/or instructions can be updated periodically (e.g., once a month, once a week, once a day, etc.), or can be updated continuously in near real time. In such instances, the sign may operate as instructed by the remote system. Alternatively, in some instances, the remote system may provide content or access to a content repository, and the sign may autonomously determine content to display based on conditions in the environment (e.g., traffic, pedestrians, location, time of day, weather, etc.). Any combination of processing between the sign and the remote system is envisioned.

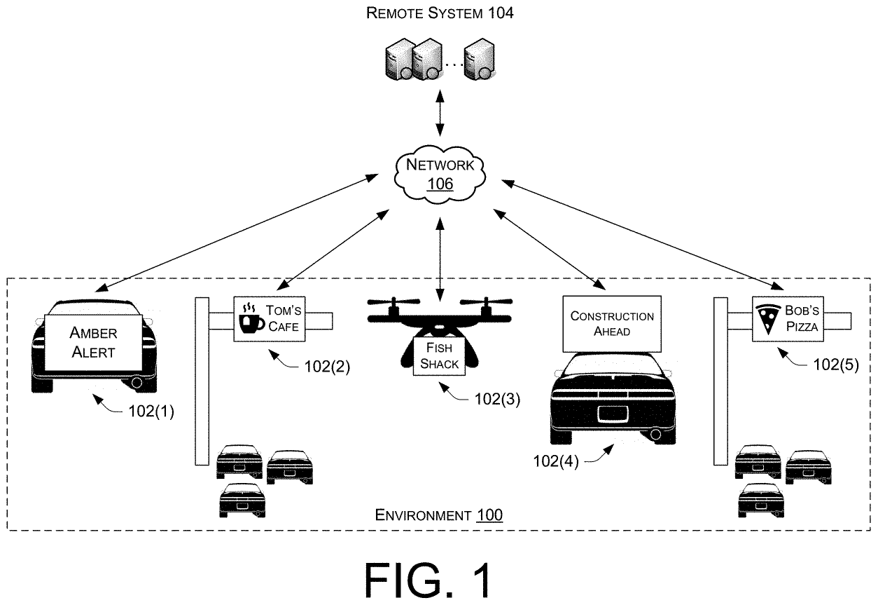

FIG. 1 illustrates an example environment 100 that includes a plurality of signs. The environment 100 may be representative of cities, geographical areas (e.g., blocks), zones, regions, places, and so forth. For example, the environment 100 may represent a city or a portion thereof (e.g., downtown). In some instances, the signs may be stationary signs that are immobile within the environment 100 or the signs may be mobile within the environment 100. For example, FIG. 1 illustrates that the environment 100 may include a first sign 102(1), a second sign 102(2), a third sign 102(3), a fourth sign 102(4), and a fifth sign 102(5). In some instances, the first sign 102(1), the second sign 102(2), the third sign 102(3), the fourth sign 102(4), and the fifth sign 102(5) may be collectively referred to as “the signs 102” or singularly, as “the sign 102.”

The first sign 102(1), the third sign 102(3), and the fourth sign 102(4) are shown being mobile within the environment 100. The first sign 102(1), the third sign 102(3), and the fourth sign 102(4) may couple to vehicles (e.g., cars, bus, trucks, etc.), UAVs, trailers, trains, and the like. As illustrated in the environment 100, the first sign 102(1) may couple to a rear of a vehicle, the third sign 102(3) may couple to a UAV, and the fourth sign 102(4) may couple to a top of a vehicle. In some instances, the respective vehicles to which the first sign 102(1), the third sign 102(3), and the fourth sign 102(4) couple may supply power to the first sign 102(1), the third sign 102(3), and the fourth sign 102(4). For example, the vehicles may include batteries, engines, alternators, generators, solar panels, and the like for powering the first sign 102(1), the third sign 102(3), and the fourth sign 102(4), respectively. Conversely, the second sign 102(2) and the fourth sign 102(4) are shown coupled to gantries disposed above a road (e.g., highway, interstate, roadway, street, etc.) In some instances, the second sign 102(2) and the fourth sign 102(4) may be disposed on other vertical structures either above, or adjacent to, the road.

The signs 102 are configured to output content for viewing by viewers. In some instances, the viewers may include drivers on the road, occupants of other vehicles on the road (e.g., passengers), bystanders or pedestrians on sidewalks, and so forth. In some instances, the content output by the signs 102 may be variable and according to certain characteristics. For example, the content output by the signs 102 may be based on a speed of vehicles within a viewing range of the signs 102, a location of the signs 102 within the environment, a number of viewers within the viewing range of the signs 102, a route along which the sign travels (in the case of mobile signs), a time of day, a speed of the vehicle to which the signs 102 couple (in the case of mobile signs), and so forth. In some instances, the content may be static (e.g., still image, blank screen, etc.) or dynamic (e.g., video, series of images, etc.).

The signs 102 are shown being communicatively coupled to a remote system 104 via a network 106. The network 106 is representative of any type of communication network and may be implemented using wired infrastructure (e.g., cable, CAT5, fiber optic cable, etc.), a wireless infrastructure (e.g., RF, cellular, microwave, satellite, Bluetooth, etc.), and/or other connection technologies.

The remote system 104 may communicatively couple to the signs 102 for controlling an operation of the signs 102 and/or transmitting content to be presented by the signs 102. For example, the remote system 104 may determine content that is to be presented on the signs 102. In some instances, the content determined for presentation may be based on characteristics of the sign 102, the environment 100, a location of the sign 102 within the environment 100, and so forth, as noted above. For example, the remote system 104 may determine a location of the signs 102 within the environment 100 (e.g., via a location component, such as GPS), and based at least in part on the location, may transmit certain content to the signs 102 for output. Noted above, this content may include static content and/or dynamic content.

The remote system 104 may also control an operation of the signs 102 based on other characteristics as well, such as a route of the sign 102 within the environment 100 (in instances where the sign is mobile, a location of the sign, etc.). In some instances, the remote system 104 may control an operation of the signs to minimize or maximize a repeatedness of content display by the signs 102 within the environment 100.

The signs 102 may be adjustable to alter a viewing range of the content displayed. For example, the signs 102 may be tilted such that viewers within a certain range of the signs 102 are able to observe the content being displayed, whereas viewers outside of the certain range may be unable to observe the content being displayed. In such instances, the signs 102 may be oriented towards a particular viewing audience within the environment 100 or towards a particular region within the environment 100. In this sense, the signs 102 may be oriented towards particular audiences or areas proximate to the signs 102.

In such examples, the signs may use the sensor data to adjust the range of viewing angles that are visible to the target audience and select the viewing angle from the range of viewing angles that maximizes a likelihood that the target audience views the content. For example, the sensor data may indicate speeds of vehicles, a number of detected vehicles, a location of the vehicles proximate to the sign, and so forth. Techniques for adjusting an orientation of a sign and/or capturing sensor data are disclosed in for example, U.S. patent application Ser. No., 17/165,488, filed Feb. 2, 2021, the entirety of which is herein incorporated by reference.

In some instances, the signs 102 may include a privacy filter or other structure that prohibits or limits occupants of vehicles outside the viewing angle from viewing the displayed content. Restricting the displayed content in this manner may minimize or prevent driver distraction. However, as the vehicles approach the signs 102 and/or are within the predetermined range (or viewing angles), the driver and/or the occupants of the vehicles may observe the displayed content. In this manner, the signs 102 may control viewing of the displayed content to within the predetermined range of the signs 102. Additional details of using a privacy filter or other structure to limit display of a sign is disclosed in for example, U.S. patent application Ser. No., 17/165,488, filed Feb. 2, 2021, the entirety of which is herein incorporated by reference.

Although the environment 100 is shown including a certain number of signs 102, the environment 100 may include more than five signs or less than five signs. Additionally, the remote system 104 may communicatively couple to signs located in other environments. For example, the environment 100 shown in FIG. 1 may represent a geographical area corresponding to a city. The remote system 104 may additionally couple to signs located in another geographical area, such as another city or other geographical area within the same city. Here, the remote system 104 may communicatively couple to any number of signs, within any disparate number of environments, for respectively controlling an operation of the signs. Moreover, multiple remote systems 104 may be embodied to control the operation of the signs 102 across the environments.

In some instances, the remote system 104 may be implemented as one or more servers and may, in some instances, form a portion of a network-accessible computing platform implemented as a computing infrastructure of processors, storage, software, data access, etc. that is maintained and accessible via a network such as the Internet. The remote system 104 does not require end-user knowledge of the physical location and configuration of the system that delivers the services. Common expressions associated for the remote system 104 include “on-demand computing”, “software as a service (SaaS)”, “platform computing”, “network-accessible platform”, “cloud services”, “data centers”, etc. Although shown as being separate from the environment 100, in some instances, the remote system 104 may reside within the environment 100.

In some instances, the signs 102 may be configured in one or more networks (e.g., mesh networks, star networks, etc.) using wireless or wired network connections for communication with each other and/or the remote system 104. Communication may come by way of Wi-Fi, Cellular, Bluetooth, Zigbee, power line communication (PLC), and other possible wireless and/or wired connection standards. For instance, in some examples, one of the signs 102 (or a relay) may communicate with the remote system 104 and that sign/relay may communicate with the other signs in the network. Moreover, in some instances, some of the signs 102 may be grouped together within respective networks, which in some instances, may be associated with geographical regions.

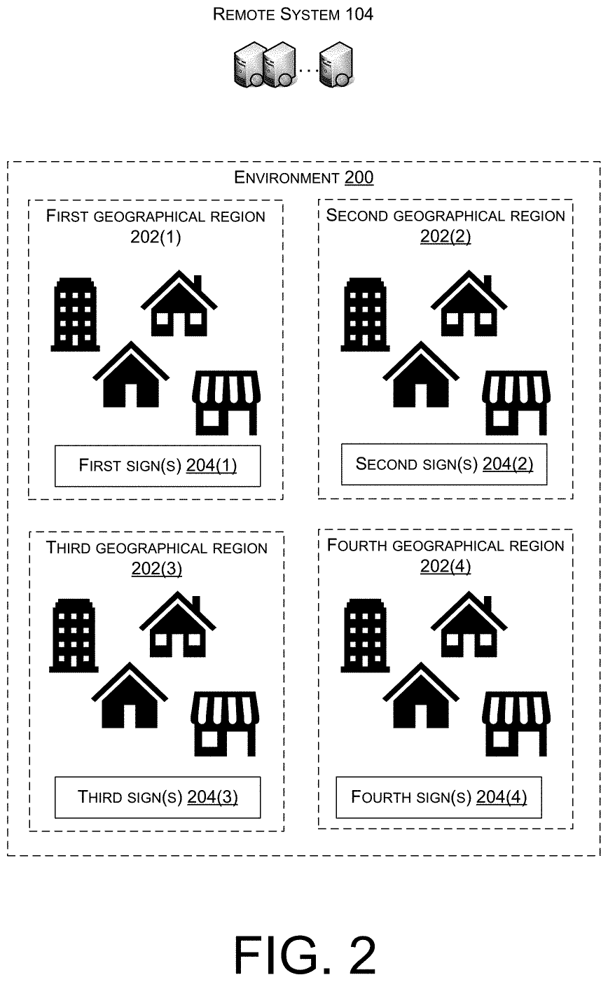

FIG. 2 illustrates example geographical regions within an environment 200. In some instances, each of the geographical regions of the environment 200 may be associated with areas, geographical coordinates, blocks, streets, zones, and so forth. The geographical regions may be established, among other things, to reduce (or eliminate) presenting duplicative content within the environment 200.

The environment 200 is shown including a first geographical region 202(1), a second geographical region 202(2), a third geographical region 202(3), and a fourth geographical region 202(4). Signs may be located within each of the geographical region, whether mobile and/or stationary. For example, the first geographical region 202(1) may include first sign(s) 204(1), the second geographical region 202(2) may include second sign(s) 204(2), the third geographical region 202(3) may include third sign(s) 204(3), and the fourth geographical region 202(4) may include fourth sign(s) 204(4).

The remote system 104 may determine content to be output by the sign(s) within the first geographical region 202(1), the second geographical region 202(2), the third geographical region 202(3), and the fourth geographical region 202(4), respectively. The sign(s) in the environment 200 may be similar to the signs 102 as discussed above with regard to FIG. 1. For example, within the first geographical region 202(1), the remote system 104 may determine first content to be displayed by a first sign of the first sign(s) 204(1) and second content to be displayed by a second sign of the first sign(s) 204(1). Here, the first content and the second content may be different. As such, the first sign(s) 204(1) may display different content throughout the first geographical region 202(1) for reducing (or eliminating) the same content being presented within the first geographical region 202(1). However, the remote system 104 may determine a plurality of content (e.g., static and dynamic) for each of the first sign(s) 204(s), where the plurality of content may be different from one another.

Additionally, or alternatively, in some instances, the remote system 104 may determine different content to be displayed by the sign(s) amongst different geographical region(s). For example, in the first geographical region 202(1), the first sign(s) 204(1) may output first content, whereas in the second geographical region 202(2), the second sign(s) 204(2) may output second content. As vehicles travel about the first geographical region 202(1), the drivers and/or occupants may observe the first content. However, as the vehicles travel to the second geographical region 202(2), the drivers and/or occupants may observe the second content. This may result in the drivers and/or occupants viewing different content when traveling to different geographical regions.

In some instances, the geographical regions 202 may be associated with respective networks. For example, the first sign(s) 204(1) within the first geographical region 202(1) may form a first network of signs, the second sign(s) 204(2) within the second geographical region 202(2) may form a second network of signs, and so forth. In some instances, the first network of signs, the second network of signs, and so forth may be separate networks or may be a set of networks. In some instances, if signs move from one geographical region to another, the signs may automatically migrate to another network. For example, if a sign among the first sign(s) 202(1) moves from the first geographical region 202(1) to the second geographical region 202(2), the sign may join the network of second sign(s) 204(2) for communicating amongst the second sign(s) 204(2). Moreover, in such instances, the remote system 104 may transmit updated content for the sign to display based at least in part on the sign moving to a different geographical region.

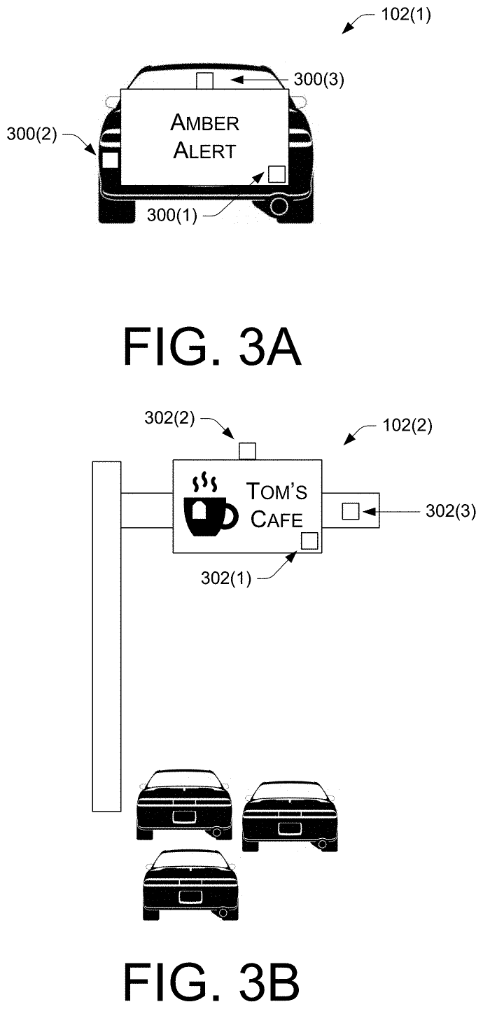

FIG. 3A illustrates an example sign, such as the first sign 102(1). The first sign 102(1) may include one or more first sensors 300(1)-(3) for capturing data within an environment. In some instances, the one or more first sensors 300(1)-(3)may be disposed on the vehicle, atop the first sign 102(1), within the first sign 102(1), and so forth. Data generated by the one or more first sensors 300(1)-(3) may be transmitted to the remote system 104 for use in controlling an operation of the first sign 102(1) and/or other signs within the environment.

FIG. 3B illustrates an example sign, such as the second sign 102(2). The second sign 102(2) may include one or more second sensors 302(1)-(3) for capturing data associated with the environment. In some instances, the one or more second sensors 302(1)-(3) may be disposed on a gantry to which the second sign 102(2) couples, atop the second sign 102(2), within the second sign 102(2), and so forth. Data generated by the one or more second sensors 302(1)-(3) may be transmitted to the remote system 104 for use in controlling an operation of the second sign 102(2) and/or other signs within the environment.

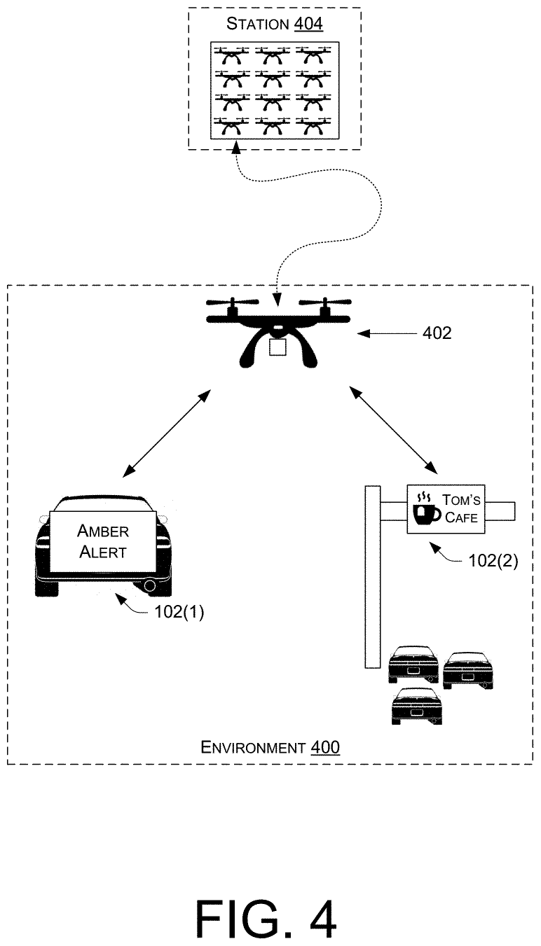

FIG. 4 illustrates an example environment 400 in which a UAV 402 communicatively couples to one or more signs. In some instances, the UAV 402 may travel from a remote location in which the UAV 402, as well as other UAVs, are stationed. The remote location may be located remote from the environment 400 or may be located within the environment 400. The remote location may generally be associated with a station 404 in which the UAV 402 docks, recharges, and so forth. In some instances, the remote system 104 may control an operation of the UAV 402, as well as other UAVs associated with the station 404.

In some instances, the UAV 402 may travel to the environment 400 for collecting information about the environment 400. The UAV 402 may include one or more sensors for collecting information about the environment 400. For example, within the environment 400, the UAV 402 may collect data associated with a speed of vehicles, a number of vehicles, a location of sign(s), and so forth. In some instances, the UAV 402 may transmit this data to the remote system 104, which in turn, may control an operation of sign(s) in the environment 400. For example, the UAV 402 may determine a location of the first sign 102(1) and the second sign 102(2), transmit indications thereof to the remote system 104, and in response, the remote system 104 may instruct the first sign 102(1) and the second sign 102(2) to display certain content. This content may be based on the location of the first sign 102(1) and the second sign 102(2), a number of vehicles within a viewing range of the first sign 102(1) and the second sign 102(2), pedestrians within a viewing range of the first sign 102(1) and the second sign 102(2), viewers adjacent to the first sign 102(1) and the second sign 102(2), a speed of the first sign 102(1), or other information capable of being collected by the UAV 402.

Additionally, or alternatively, the UAV 402 may communicate with the first sign 102(1) and the second sign 102(2) to provide the first sign 102(1) and the second sign 102(2) information about the environment 400. For example, the UAV 402 may collect information about a number of viewers within a viewing range of the first sign 102(1), and in response, may instruct the first sign 102(1) to orient in a particular direction, output certain content, and so forth. In some instances, the UAV 402 may provide information about the environment 400 to the first sign 102(1) and the second sign 102(2) for use by the first sign 102(1) and the second sign 102(2), respectively, when outputting certain content. In some instances, the UAV 402 may be deployed to capture information about the environment 400 based on requests received from the first sign 102(1) and the second sign 102(2) or the remote system 104 may display the UAV 402.

The UAV 402 may also transmit data to the first sign 102(1) and the second sign 102(2) as instructed by the remote system 104. For example, the UAV 402 may transmit content to the first sign 102(1) and the second sign 102(2) for output. Here, the UAV 402 may act as an interface between the remote system 104 and the first sign 102(1) and/or the second sign 102(2).

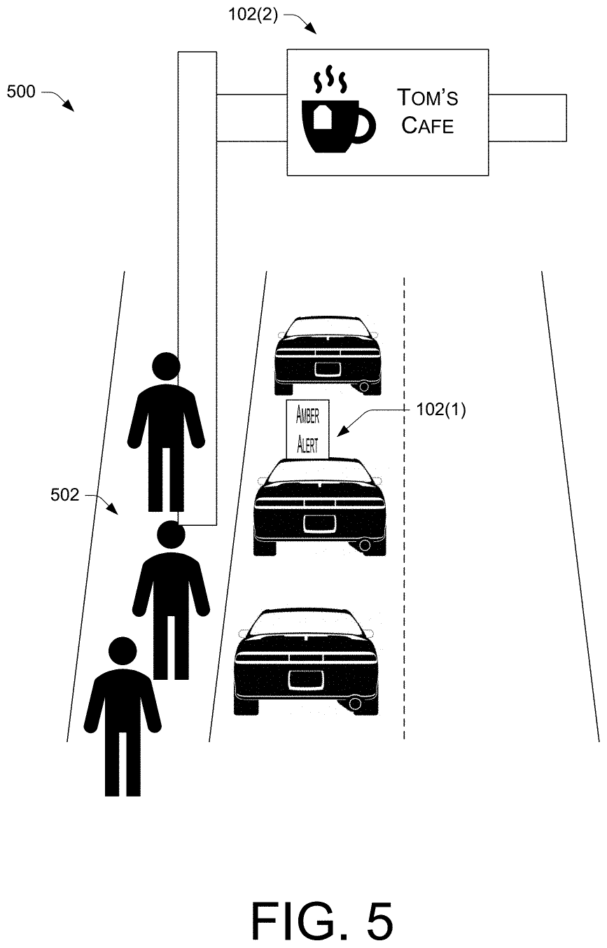

FIG. 5 illustrates an example environment 500 that includes the first sign 102(1) and the second sign 102(2). As shown, the first sign 102(1) may be coupled to a vehicle traveling along the roadway, while the second sign 102(2) may be coupled to a gantry (or other structure) disposed over a roadway. A sidewalk is shown adjacent to the roadway and one or more pedestrians 502 may walk on the sidewalk.

The first sign 102(1) and/or the second sign 102(2) may orient towards the pedestrians 502. In some instances, the first sign 102(1) and/or the second sign 102(2) may orient towards the pedestrians 502 based at least in part on detecting a presence of the pedestrians 502 within a viewing range of the first sign 102(1) and the second sign 102(2), respectively. In some instances, based at least in part on detecting the presence of the pedestrians 502 and/or orienting towards the pedestrians 502, the first sign 102(1) and/or the second sign 102(2) may output dynamic content. For example, in instances where the first sign 102(1) and/or the second sign 102(2) present content to the pedestrians 502, the first sign 102(1) and/or the second sign 102(2) may output dynamic content. In such instances, the display of dynamic content may not be based on a speed of other vehicles in the environment 500.

As illustrated, the environment 500 may include multiple pedestrians 502. In such instances, the first sign 102(1) and/or the second sign 102(2) may orient to maximize the viewing to the pedestrian(s) 502.

In some instances, the first sign 102(1) and/or the second sign 102(2) may include speakers that output audio in a direction towards the pedestrians 502. For example, the first sign 102(1) and/or the second sign 102(2) may include a phased array of speakers that output audio in a particular direction. In some instances, the audio may be output (e.g., steered) to a particular pedestrian among the pedestrian(s) 502.

Although FIG. 5 illustrates a particular arrangement of the first sign 102(1) and the second sign 102(2), other embodiments are envisioned. For example, the environment 500 may include multiple mobile signs and/or multiple stationary signs. In one particular example, more than one sign may be disposed above the roadway, adjacent to the second sign 102(2) on the gantry. In such instances, the second sign 102(2) may be oriented to output content to the pedestrians 502, while the additional sign may be oriented to output content to the vehicles. In such instances, the second sign 102(2) may output dynamic content to the pedestrian(s) 502, whereas the additional sign disposed above the roadway may output content to the vehicles, and where the content output is based at least in part on the speeds of the vehicles on the roadway. For example, if the speeds of the vehicles are greater than a threshold speed, the additional sign may output static content, whereas if the speeds of the vehicles are less than the threshold speed, the additional sign may output dynamic content.

In some instances, the first sign 102(1), the second sign 102(2), and/or other signs in the environment 500 may be oriented to areas that are known to be trafficked by the pedestrians 502 (e.g., sidewalk, crosswalk, etc.). In some instances, a technician installing the sign or serving the sign may determine areas known to be trafficked by the pedestrians 502, and/or may orient the sign towards the areas known to be trafficked by the pedestrians 502. Additionally, or alternatively, the signs 102 and/or the remote system 104 may orient the signs 102 automatically based on map data, and/or based on image processing of the environment.

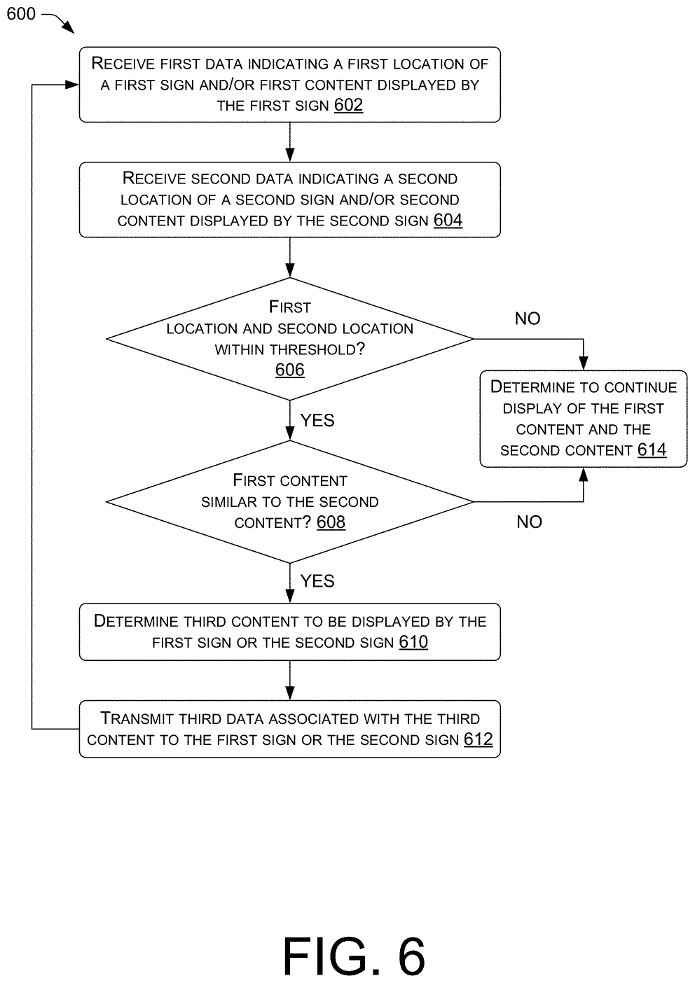

FIGS. 6-11 illustrate various processes related to controlling operations of a sign. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures, devices, and systems described in the examples herein, such as, for example those described with respect to FIGS. 1-5, although the processes may be implemented in a wide variety of other environments, architectures, devices, and systems.

FIG. 6 illustrates an example process 600 for controlling an operation of one or more signs. At 602, the process 600 may include receiving first data indicating a first location of a first sign and/or first content displayed by the first sign. For example, the remote system 104 may receive data from a first sign that indicates a geographical location of the first sign within an environment and/or content being displayed by the first sign. The first data may also indicate a route of the first sign, a bearing of the first sign, a speed of the first sign, and so forth. In some instances, the process 600 may receive the first data based on a request transmitted to the first sign and/or according to a predetermined scheduled (e.g., every 10 seconds, minute, etc.). In some instances, the first sign may represent a mobile sign.

At 604, the process 600 may include receiving second data indicating a second location of a second sign and/or second content displayed by the second sign. For example, the remote system 104 may receive data from a second sign that indicates a geographical location of the second sign within an environment and/or content being displayed by the second sign. The second data may also indicate a route of the second sign, a bearing of the second sign, a speed of the second sign, and so forth. In some instances, the process 600 may receive the second data based on a request transmitted to the second sign and/or according to a predetermined. In some instances, the second sign may represent a mobile sign.

At 606, the process 600 may include determining whether the first location and the second location are within a threshold. For example, the remote system 104 may compare the first location of the first sign and the second location of the second sign. Comparison of the first location and the second location may indicate how close, or proximate, the first sign and the second sign are to one another within the environment. If the locations (e.g., GPS coordinates) are within a certain threshold location (e.g., 1000 feet, 1 mile, etc.) of one another, the process 600 may follow the “YES” route and proceed to 608.

At 608, the process 600 may include determining whether the first content and the second content are similar. For example, the remote system 104 may determine whether the first sign and the second sign are outputting the same content (e.g., same advertisement) and/or similar content (e.g., food-based advertisement). In some instances, the remote system 104 may use identifiers associated with the first content and/or the second content to determine whether the content is similar. If the process 600 determines that the first content and the second content are similar, the process 600 may follow the “YES” route and proceed to 610.

At 610, the process 600 may include determining third content to be displayed by the first sign or the second sign. For example, based at least in part on the first sign and the second sign being within the threshold, and displaying similar content, the remote system 104 may determine new content to display on one of the first sign or the second sign. This may include, for example, determining updated content to reduce a repetitiveness of content displayed in the environment. Moreover, as part of this determination, the remote system 104 may determine content being displayed by other signs in the environment, that are proximate to the first sign or the second sign. As such, the third content selected for display may be based on the location and/or the content being displayed by other signs in the environment.

At 612, the process 600 may include transmitting third data associated with the third content to the first sign or the second sign. For example, the remote system 104 may transmit the third content to the first sign or the second sign for output. In response, the first sign or the second sign may display the third content. From 612, the process 600 may loop to 602 whereby the process 600 may continually determine whether the first sign and the second sign (or additional signs) are within the threshold location and/or displaying similar content.

Alternatively, if the first location and the second location are not within the threshold, the process 600 may follow the “NO” route and proceed to 614. At 614, the process 600 may include determining to continue display of the first content and the second content. For example, if the first sign and the second sign are not within the threshold distance of one another, the first sign may continue to display the first content and the second sign may continue to display the second content. The process 600 further illustrates that the process 600 may proceed to 614 following the “NO” route from 608.

Although the process 600 is discussed as being performed by the remote system 104, the process 600 (or portions thereof) may be performed by the first sign and/or the second sign. For example, the first sign may determine whether the second sign is within a certain threshold of the first sign and/or whether the first sign and the second sign are outputting similar content. If so, the first sign may determine new content to display and/or may instruct the second sign to display other content. However, in instances where the process 600 is performed by the remote system 104, the process 600 may be carried out autonomously.

Alternatively, rather than being location-based, the process 600 may determine whether the signs are within a certain time threshold of one another (e., using location, bearing, speed, etc.). Additionally, in some instances, the remote system 104 may determine whether the routes of the first sign and the second sign are the same, rather than determining whether the signs are within the threshold location of one another. For example, routes of the first sign and the second sign may include adjacent streets within an environment. In some instances, the first sign and the second sign may be within a threshold location, but may display similar content because the first sign and the second sign are on different routes (e.g., streets).

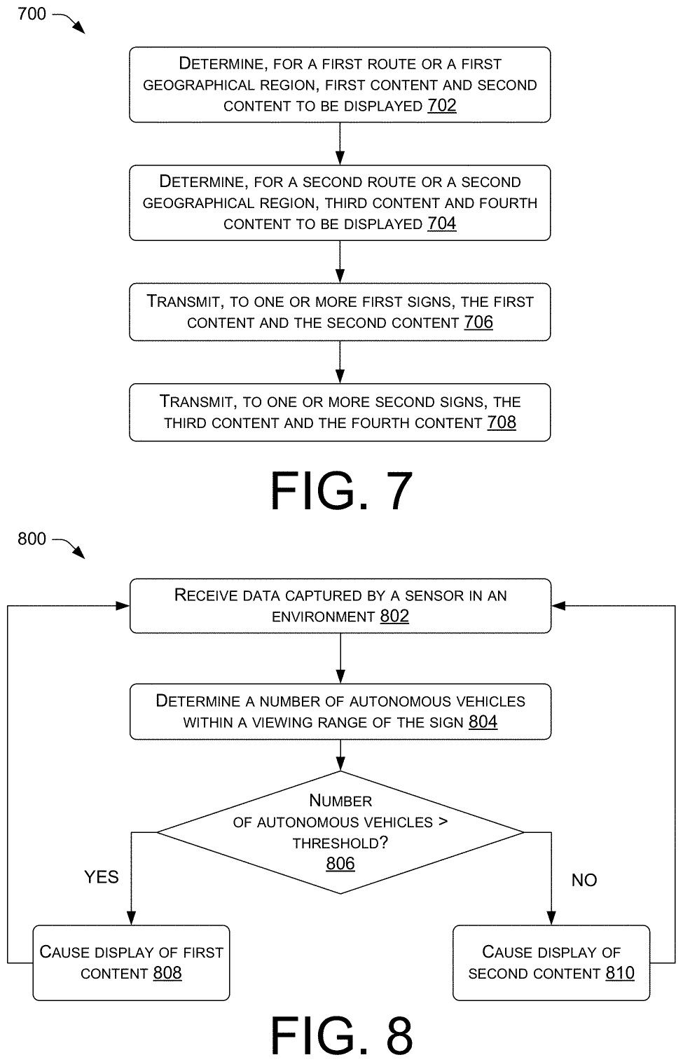

FIG. 7 illustrates an example process 700 for transmitting content to signs associated with different routes and/or geographical regions.

At 702, the process 700 may include determining, for a first route or a first geographical region, first content and second content to be displayed. In some instances the first route may include a first path in which a first vehicle is to travel for displaying content on a sign (in instances where the sign is mobile). Additionally, in some instances, the first content and the second content may be determined for a geographical region, such as certain blocks within a city, or a certain region of a city (e.g., downtown). In some instances, the first content may represent content that is static (e.g., blank, still image, etc.) whereas the second content may represent content that is dynamic (e.g., series of image(s), video, etc.). The first content may be displayed when the speed of vehicles within a viewing range of the sign is greater than a threshold and the second content may be displayed when the speed of the vehicles within the viewing range is less than the threshold.

At 704, the process 700 may include determining, for a second route or a second geographical region, third content and fourth content to be displayed. In some instances the second route may include a second path in which a second vehicle is to travel for displaying content on a sign (in instances where the sign is mobile). Here, the second path may be different than the first path. Additionally, in some instances, the third content and the fourth content may be determined for a geographical region, such as certain blocks within a city, or a certain region of a city (e.g., downtown). In some instances, the second geographical region may be different than the first geographical region (e.g., different blocks, location, area, etc.). The third content may represent content that is static (e.g., blank, still image, etc.) whereas the fourth content may represent content that is dynamic (e.g., series of image(s), video, etc.). In some instances, the first content may be different than the third content, and/or the second content may be different than the fourth content.

At 706, the process 700 may include transmitting, to one or more first signs, the first content and the second content. As alluded to above, the one or more first signs may output the first content and the second content, whether mobile or stationary.

At 708, the process 700 may include transmitting, to one or more second signs, the third content and the fourth content. The one or more second signs may output the third content and the fourth content, whether mobile or stationary.

In some instances, the process 700 may involve determining different content for signs within the same geographical region. For example, the process 700 may determine content for display on a first sign within the first geographical region, and content for display on a second sign within the first geographical region. The content may be different such that viewers within the first geographical region are not presented duplicative content.

FIG. 8 illustrates an example process 800 for controlling an operation of a sign based on detecting autonomous vehicles within a proximity of the sign. In some instances, the sign and/or the remote system 104 (or components thereof) may perform, or at least partially perform, the process 800.

At 802, the process 800 may include receiving data captured by a sensor in an environment. In some instances, the sign may include a controller that receives the data from the sensor, or the sensor may be decoupled from the sign and provide the data to the sign and/or the remote system 104. The sensor may be disposed on a sign, adjacent to a sign, or a UAV, etc. In some instances, the sensor may be disposed to capture an area in front of the sign or an area within a viewing range of the sign. The sensor, for example, may include LIDAR, cameras, RADAR, etc.

At 804, the process 800 may include determining a number of autonomous vehicles within a viewing range of the sign. For example, the sign and/or the remote system 104 may analyze the data to determine a number of autonomous vehicles within the viewing range of the sign. In some instances, the sign and/or the remote system 104 may utilize various techniques for analyzing the data and determining the number of autofocus vehicles. For example, the sign may perform object segmentation to identify identifiers of the autonomous vehicles (e., emblems, hood ornaments, stickers, etc.). Here, the data may be analyzed to determine an absence of drivers in the vehicle, a make/model of the vehicle, a size and/or shape of the car, a lack of a hood on the car, and so forth.

Additionally, or alternatively, the sign and/or the environment may include additional sensors that detect LIDAR and/or RADAR emitted by the vehicles, radio frequency signals emitted by the vehicles, and so forth. In some instances, autonomous vehicles may use such mechanism to travel about an environment. The sign (or sensors) may detect the presence of such mechanism to determine the presence of autonomous vehicles and/or the number of autonomous vehicles proximate to the sign.

At 806, the process 800 may include determining whether the number of autonomous vehicles is greater than a threshold. For example, the sign may compare the number of autonomous vehicles within the viewing range to determine whether the number exceeds a threshold. Alternatively, the process 800 at 806 may include determine whether a percentage of vehicles within the viewing range are autonomously operated (e.g., 90 percent, 95 percent, etc.). If at 806, the process 800 determines that the number of autonomous vehicles exceeds the threshold, the process 800 may follow the “YES” route and proceed to 808.

At 808, the process 800 may include causing display of first content. For example, the sign may cause output of first content, which may include dynamic content (e.g., series of images, video, etc.). In some instances, the first content may be output when the vehicles within the viewing range are operated autonomous given that occupants of the vehicles may have more attention to devote to variable content displayed on the sign (as compared to static content).

Alternatively, if at 806 the process 800 determines that the number of autonomous vehicles is not greater than the threshold, the process 800 may follow the “NO” route and proceed to 810. At 810, the process 800 may include causing display of second content. In some instances, the second content may represent static content (e.g., blank screen, single image, etc.) that is less distracting that the first content. As such, when the vehicles within the viewing range of the sign, or a certain percentage thereof, are not being operated autonomously, the sign may output static content.

From 808 and 810, the process 800 may loop to 802 whereby the process 800 may continuously receive data for determining the presence of autonomous vehicles within the viewing range of the sign.

In some instances, the process 800 output the first content even in instances where the number of autonomous vehicles does not exceed the threshold. For example, the sign may orient such that display of the first content (e.g., the dynamic content) is limited to viewing by the autonomous vehicle(s). In instances where the environment includes more than one autonomous vehicle, the process 800 may output the dynamic content to a closest autonomous vehicle, the sign may include multiple displays for outputting the content to different autonomous vehicles, and/or the sign may include directional viewing filters that directs the dynamic content to the autonomous vehicles.

Conversely, in some instances, rather than determining the number of autonomous vehicles, the process 800 may determine a number of driver-operated vehicles within the viewing range of the sign. The process 800 may compare the number of driver-operated vehicles to a threshold, and if the number of driver-operated vehicles exceeds the threshold, the process 800 may output static content. In instances where the number of driver-operated vehicles is less than the threshold, or no driver-operated vehicles are determined, the process 800 may output dynamic content.

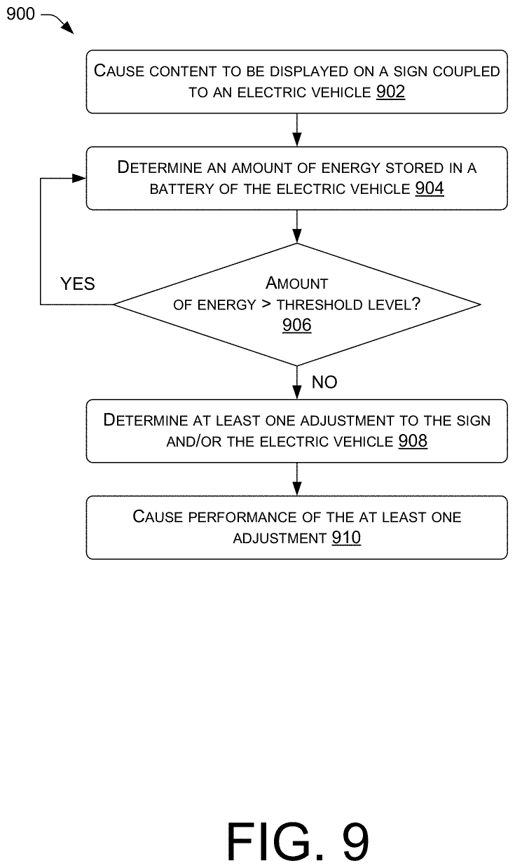

FIG. 9 illustrates an example process 900 for adjusting a sign and/or an operation of a vehicle based on an amount of power associated with the vehicle.

At 902, the process 900 may include causing content to be displayed on a sign coupled to an electric vehicle. For example, while traveling along a route within an environment, the sign may output content for viewing by bystanders, drivers of other vehicles, occupants of other vehicles, and so forth. In some instances, the content output on the sign may be based at least in part on a location of the sign, a speed of the vehicle, a time of day, and the like. Additionally, during display of the content, the sign may be positioned at a first position (e.g., upright) for viewing. In some instances, the first position of the sign may include a first height relative to the vehicle, a first orientation relative to the vehicle, and so forth. Moreover, in some instances, display of the content at 902 may include displaying a succession or series of content (e.g., multiple images). In this sense, the sign may cycle through content being output for viewing by viewers. In some instances, the sign may be powered at least in part by power sources (e.g., batteries, engine, generator, polar panels, etc.) of the vehicle to which the sign couples. Additionally, or alternatively, the sign may possess its own power sources (e.g., battery, solar panel, etc.).

At 904, the process 900 may include determining an amount of energy stored in a battery of the electric vehicle. In some instances, the sign, the vehicle, the remote system 104, and/or another device may determine the amount of energy stored in the battery (or batteries). In some instances, the amount of energy may be associated with a state of charge of the battery (e.g., 50% charged, 75% charged, etc.). The amount of energy may be determined by sensing a charge of the battery.

At 906, the process 900 may include determining whether the amount of energy is greater than a threshold level. For example, the sign, the vehicle, the remote system 104, and/or the other device may determine whether the current amount of energy stored in the battery (or batteries) is greater than a threshold level. In some instances, the threshold level may be associated with a depleted state of the battery, such as a 25% charge, or other minimum amount by which an adjustment may be made to the vehicle and/or the sign. For example, while in an upright position, the sign may impart drag to the vehicle. This drag, over time, may drain the battery at a faster rate than if the sign was in descended (or less upright) position. For example, as the vehicle travels throughout an environment, the upright position of the sign may provide resistance to the vehicle and the vehicle may overcome those resistances to move about the environment. This may demand may increase power and consume a greater amount of energy stored in the battery.

If at 906 the process 900 determines that the amount of energy is greater than the threshold level, the process 900 may follow the “YES” route and loop to 904. Here, the process 900 may continuously determine the amount of energy stored in the battery for comparing against the threshold level. Alternatively, if at 906 the process 900 determines that the amount of energy stored in the battery is less than the threshold level, the process 900 may follow the “NO” route and proceed to 908.

At 908, the process 900 may include determining at least one adjustment to the sign and/or the electronic vehicle. For example, to reduce drag on the vehicle, the sign may transition to a second lowered position, may orient such a display of the sign is more parallel to a direction of travel, may tilt, and so forth. Here, a height of the sign may be decreased to reduce drag. Additionally, a speed of the vehicle may be reduced to reduce the drag. Reducing the drag on the vehicle may conserve energy of the battery.

At 910, the process 900 may cause performance of the at least one adjustment. For example, the sign may be lowered, an orientation of the sign may adjust, and/or the vehicle speed may be reduced. In some instances, the sign may automatically raise and lower or indications may be output to a driver of the vehicle for raising and lowering the sign. Moreover, the adjustment to the sign may be controlled by a remote operator or by the remote system 104.

In some instances, the process 900 may determine an optimized route for the vehicle and/or an orientation of the sign based on the remaining charge of the battery. For example, the process 900 may determine a route that avoids speeds above a threshold and/or a route that travels through densely populated and/or trafficked areas for optimizing a viewing of the content. The process 900 may determine a route, for example, in which to optimize display of the sign for a given battery charge. This may include, for example, outputting certain content on the sign (e.g., static or dynamic) to conserve battery usage or to adjust a display schedule at which the sign transitions between displaying different content on the sign.

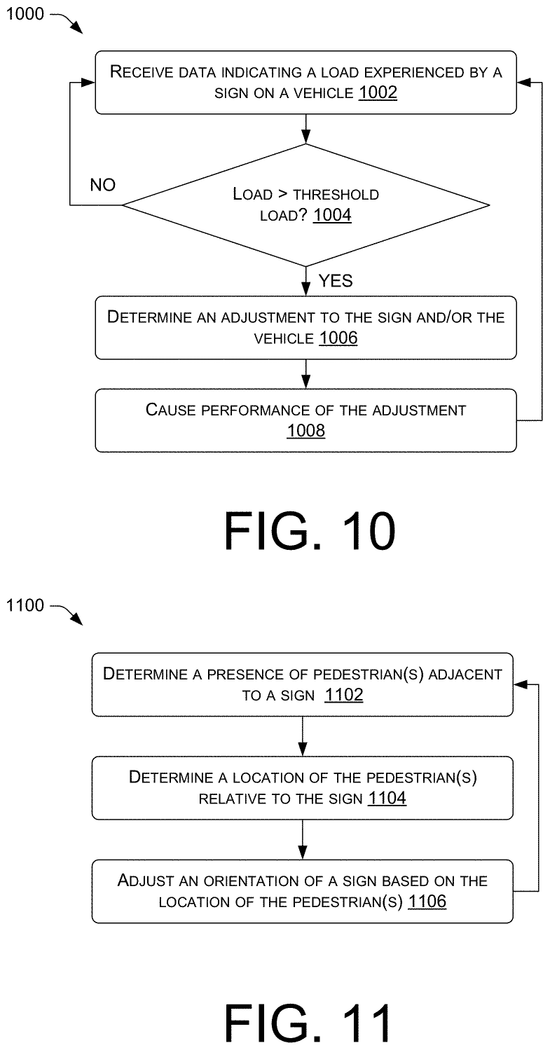

FIG. 10 illustrates an example process 1000 for adjusting a sign based on loads experienced by the sign. At 1002, the process 1000 may include receiving data indicating a load experienced by a sign on a vehicle. In some instances, a sensor of the sign may generate data indicating a load experienced by the sign. By way of illustration, in an elevated position, the sign may experience a wind load as the vehicle travels about an environment. The sensor that generates the data may include a strain gauge placed on the sign, a sensor that measures torque applied to arms (or other structural members) of the sign, a sensor that measures a deflection of the sign, and so forth. The sensor(s) may be placed on or about various parts of the sign and/or component of the sign. For example, a pivot, joint, or other mechanism may permit the sign to transmit between an elevated position and a lowered position, and a load experienced at the pivot may be measured. In some instances, the load applied to the sign may be based on a size of the sign (e.g., surface area), a speed of the vehicle, a weight of the sign, shapes/contours of the sign, and so forth. The load may be represented in Newtons (N), Newton-meters (Nm), pounds (lbs), foot-pounds (ft-lb), etc.

At 1004, the process 1000 may include determining whether the load is greater than a threshold load. For example, the sign may include controllers that receive the data indicating the load and compare the load to a threshold load. The threshold load may be determined based on characteristics of the sign to prevent damage to the sign and/or the vehicle to which the sign couples. For example, if the load experienced by the sign, or other structural components of the sign, is greater than the threshold load, ensuing damage may be caused to the sign and/or the vehicle. For example, if the torque applied to the pivot, for example, exceeds a threshold torque, the sign may be lowered.

If at 1004 the process 1000 determines that the load is not greater than the threshold load, the process 1000 may follow the “NO” route and loop to 1002 whereby the process 1000 may continuously determine whether the load is greater than the threshold load. Alternatively, if at 1004 the process 1000 determines that the load is greater than the threshold load, the process 1000 may follow the “YES” route and proceed to 1006.

At 1006, the process 1000 may include determining an adjustment to the sign and/or the vehicle. For example, the sign may determine to lower in height and/or orient the sign (e.g., angle) to reduce experienced loads (e.g., descend). Additionally, or alternatively, a vehicle speed may be lessened to reduce the experienced load. In some instances, the adjustments determined may be based on maximum loads capable of being experienced by the sign, or to reduce the load below the threshold load.

At 1008, the process 1000 may include causing performance of the adjustment. For example, the sign or a controller thereof may cause an actuator to actuate to lower the sign and/or change an orientation of the sign. As a result, the load experienced by the sign may be reduced. From 1008, the process 1000 may loop to 1002 whereby the process 1000 may continuously determine the loads experienced by the sign for use in adjusting the sign. For example, if the vehicle slows down and the loads on the sign are lessened, the sign may be raised to increase a height of the sign above the vehicle.

In some instances, the sign may be coupled to a vehicle, such as a car, or other mobile platform, such as a trailer. Additionally, rather than the sign determining the experienced loads and determining the adjustment, the sign may communicatively couple with the remote system 104 and the remote system 104 may determine whether to adjust the sign. Additionally, although the process 1000 may illustrate a scenario whereby the sign automatically adjusts based on the experienced loads, indications may be provided (e.g., output on a mobile device, interface, etc.) to an operator of the vehicle for causing the adjustments to the sign. For example, the operator may provide indications to raise and/or lower the sign based on sensed loads.

FIG. 11 illustrates an example process 1100 for determining a presence of pedestrians within a sign and orienting the sign towards the pedestrians.

At 1102, the process 1100 may include determining a presence of pedestrians adjacent to the sign. In some instances, the sign may include sensors that detect the presence of pedestrians adjacent to the sign. Additionally, or alternatively, other devices in an environment of the sign may include sensors to determine the presence of pedestrians. In some instances, the sensors may determine the presence of pedestrians within a viewing range of the sign. In some instances, the sensors may be oriented to locations where pedestrians are known to commute (e.g., crosswalk, sidewalks, entrances/exits to buildings, etc.).

At 1104, the process 1100 may include determining a location of the pedestrians relative to the sign. For example, based at least in part on determining the presence of the pedestrians, a location of the pedestrians may be determined. In some instances, the location of the pedestrians may correspond to determining a coordinate positions of the pedestrian(s) relative to the sign, or a distance from the sign to the pedestrian(s).

At 1106, the process 1106 may include adjusting an orientation of the sign based on the location of the pedestrian(s). For example, upon knowing the location of the pedestrian(s), the sign may tilt or otherwise orient the sign towards the pedestrian(s). In some instances, this may include adjusting a viewing angle of the sign towards the pedestrian(s). From 1106, the process 1100 may loop to 1102 whereby the process 1100 may continuously determine the presence and location of pedestrian(s).

In some instances, the sign may output or display content based on detecting pedestrian(s). For example, the sign may be blank at a first instance, and upon detecting the presence of pedestrian(s), may output content. Additionally, in instances where multiple pedestrian(s) are detected, the sign, may determine a central location of the pedestrians and adjust the sign such that the viewing range of the sign is centered adjusted towards the central position.

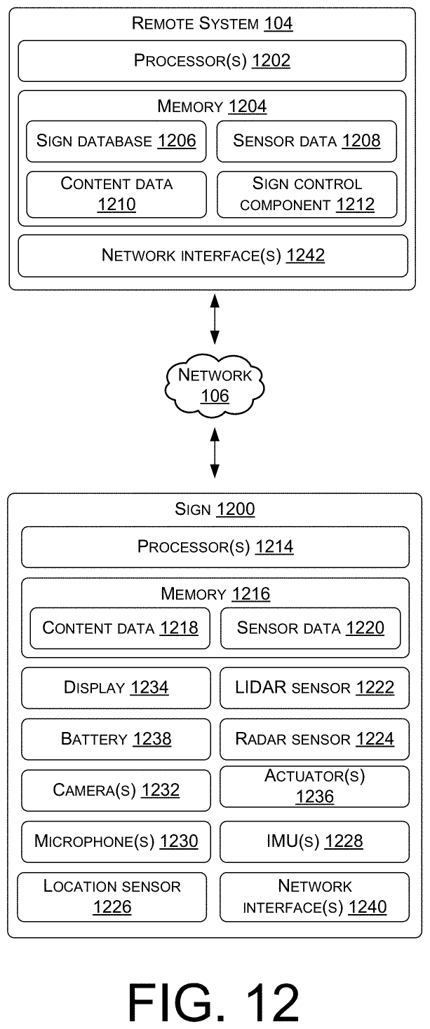

FIG. 12 illustrates example computing components of the remote system 104 and a sign 1200, such as any of the signs 102 discussed above with regard to FIG. 1. The remote system 104 and the sign 1200 are shown communicatively coupled to one another via the network 106 for exchanging and sharing information.

The remote system 104 is shown including processor(s) 1202 and memory 1204, where the processor(s) 1202 may perform various functions and operations and the memory 1204 stores instructions executable by the processor(s) 1202 to perform the operations described herein. The memory 1204 is shown storing, or otherwise having access to a sign database 1206, sensor data 1208, content data 1210, and a sign control component 1212.

The sign database 1206 may include identifiers of signs communicatively coupled to the remote system 104, such as the sign 1200. In some instances, the sign database 1206 may include information associated with the signs 102, such as location, type (e.g., mobile, stationary, etc.), size, network capabilities, network interfaces, capabilities (e.g., static content, dynamic content, etc.), and so forth. The remote system 104 may utilize the sign database 1206 for knowing which signs are communicatively coupled to the remote system 104 and/or for purposes of communicating with the signs.

The sensor data 1208 may represent information captured by the signs. For example, as discussed herein, the signs may include a plurality of sensor(s) for collecting information about an environment in which the signs reside. For example, the sensor data 1208 may include a location of the sign, a number of viewers within a viewing range of the sign, a speed of the sign, an orientation of the sign, a mode of the sign (e.g., elevated or descended), current content being displayed by the sign, a battery life of the sign, and so forth. The signs may respectively transmit the sensor data 1208 to the remote system 104 for at least partially controlling an operation thereof. For example, based on a location of the sign 1200, the sign 1200 may be instructed to display certain content. In some instances, the sensor data 1208 may additionally or alternatively be received from other devices, such as aerial vehicles, personal device(s) (e.g., mobile phone), vehicles, and so forth.

The content data 1210 may include content stored by the remote system 104 for the signs. The content data 1210 may represent the content to be display amongst the signs 102. For example, the content data may include dynamic content (e.g., videos, a series of images, etc.) and/or static content (e.g., blank images, still images, etc.). In some instances, the remote system 104 may control the content supplied to the individual signs. For example, the remote system 104 may determine content, among the content data 1210, to transmit to the signs based on a location, a time of day, a number of viewers within a viewing range of the sign, and so forth. In some instances, the content data 1210 may be transmitted to signs according to predetermined intervals (e.g., hourly, daily, etc.), based on certain triggering events (e.g., sign requesting content, signs being within certain proximity, etc.), and/or at predetermined times (e.g., start of rush-hour, beginning of day, etc.). In some instances, however, the content data 1210 may be stored on one or more third-party database(s) and the remote system 104 may act as an intermediary for supplying the content to the signs for display. Additionally, or alternatively, in some instances, the content data 1210 may be received from one or more third parties. For example, the remote system 104 may be configured to receive messages (e.g., advertisements or other content) directly from third parties (e.g., advertisers) in substantially real time. The messages may be sent to the remote system 104 using an application program interface (API) exposed to the third parties, and the content may be placed in content queues for respective signs in an environment. Moreover, the remote system 104 may present a user interface (UI) to the third parties for using the UI to upload messages/content/advertisements (whether static or dynamic). Moreover, in some examples, the third parties may specify the specific signs they want to display the content, a region within which they want to display the content, times of day, etc. The signs themselves, however, may additionally or alternatively communicative with the third parties and/or third party databases for obtaining content.

The sign control component 1212 is configured, at least in part, to control an operation of the signs and/or a display of the signs. In some instances, the sign control component 1212 may process the sensor data 1208 for controlling an operation of the sign 1200. For example, continuing with the above example, the sign control component 1212 may determine a location of the sign 1200 for causing certain content to be displayed. In other instances, the sign control component 1212 may determine a proximity of two signs relative to one another for use in determining content to display, so as to reduce redundancy of content displayed on the signs. Still, as another example, the sign control component 1212 may determine routes and/or geographical areas associated with the signs for instructing the sign to display certain content along the route and/or within the geographical area. In some instances, the remote system 104 transmits content and instructions for how the content is to be displayed by the sign 1200. For example, content and/or instructions can be updated periodically (e.g., once a month, once a week, once a day, etc.), or can be updated continuously in near real time.

In some instances, the sign 1200 may be representative of a mobile sign and/or a stationary sign. The sign 1200 is shown including processor(s) 1214 and memory 1216, where the processor(s) 1214 may perform various functions and operations and the memory 1216 stores instructions executable by the processor(s) 1214 to perform the operations described herein. The memory 1216 is shown storing, or otherwise having access to content data 1218 and sensor data 1220. In some instances, the content data 1218 may represent a portion of the content data 1208 stored in the memory 1204 of the remote system 104. For example, the content data 1218 may represent a portion of the content data 1210 that is to be displayed by the sign 1200. In some instances, the content data 1218 may include multiple instances, or types of content, to be displayed. For example, the sign 1200 may cycle through displaying different content over a certain period of time. The sensor data 1220 may similarly represent a portion of the sensor data 1208 stored in the memory 1204 of the remote system 104. For example, the sign 1200 may capture the sensor data 1220 and transmit the sensor data 1220 to the remote system 104, where the sensor data 1220 is stored as the sensor data 1208. The sign 1200 may also store the sensor data 1220 locally for use in controlling an operation of the sign 1200.

As described above, the sign 1200 may include a plurality of sensors configured to capture the sensor data 1220. For example, the sign 1200 may include a LIDAR sensor 1222, a radar sensor 1224, a location sensor 1226, IMUS 1228, microphone(s) 1230, and/or camera(s) 1232. The LIDAR sensor 1222 may measure a distance between the sign 1200 and one or more objects in an environment of the sign 1200, such as pedestrians, vehicles, roads, buildings, and so forth. In some instances, data generated by the LIDAR sensor 1222 may be used to generate a map or scene of the environment. The radar sensor 1224 uses radio waves to determine the range, angle, or velocity of a target (e.g., pedestrian, vehicle, building, road, etc.). In some instances, the sign 1200 may include any number of LIDAR sensor(s) and/or radar sensors, or may include other sensors for measuring various other parameters related to the environment, a distance or position of a viewing target, and so forth.

The location sensor 1226 may measure a location of the sign 1200. In some instances, the location sensor may represent a GPS sensor configured to generate GPS coordinates associated with the location of the sign 1200.

The IMUS 1228 may, in some instances, include accelerometers, gyroscopes, magnetometers, and so forth. The IMUS 1228 generate sensor data indicative of a movement or acceleration of the sign 1200 and forces experienced by the sign 1200. For example, the IMUs 1228 may measure a wind force experienced by the sign 1200 for use lowering the sign 1200. The microphone(s) 1230 may generate audio data associated with sound captured within an environment of the sign 1200. The camera(s) 1232 may capture image data within the environment. For example, the image(s) captured by the camera(s) 1232 may be used to determine a presence of pedestrians/vehicles within the envenom, a location of the pedestrians/vehicles, and so forth.

As discussed above, the remote system 104 may at least partially control an operation of the sign 1200. In some instances, the processor(s) 1214 may receive the content data 1218 from the remote system 104 and/or other instructions for controlling an operation of the sign 1200. In response, the processor(s) 1214 may cause the sign 1200 to display the content data 1218, and/or may cause the sign 1200 to operate according to the instructions (e.g., lower in height, raise in height, adjust in orientation, power on, power off, etc.). Additionally, or alternatively, in some instances, the remote system 104 may provide the content data 1220 or access to a content repository, and the sign 1200 may determine content to display based on conditions in the environment (e.g., traffic, pedestrians, location, time of day, weather, etc.). In some instances, the sign 1200 may additionally or alternatively include controllers and/or modules that control an operation of the sign.

The sign 1200 is further shown including a display 1234 for displaying the content data 1218, actuator(s) 1236 for raising, lowering, or otherwise adjusting an orientation of the sign 1200, and/or a battery 1238. The battery 1238 may power various components of the sign 1200. However, in some instances, the sign 1200 may be powered at least in part by the vehicle to which sign 1200 couples (in instances where the sign 1200 is a mobile sign).

As shown, the remote system 104 and the sign 1200 may include network interface(s) 1240 and network interface(s) 1242, respectively, for communicating with the signs, and/or other electronic devices (e.g., vehicles, mobile phones, other signs, etc.). The network interface(s) 1240 and/or the network interface(s) 1242 enable the remote system 104 and the sign 1200 (as well as other signs) to communicate over any type of network, such as wireless networks (e.g., Wi-Fi, Bluetooth, Personal Area Networks, Wide Area Networks, and so forth). In some instances, the sign 1200 may include cellular or satellite network interfaces (or other communications) and may serve an additional purpose of providing a Wi-Fi hotspot that adjacent users may join. For example, in exchange for providing free Wi-Fi coverage for the users, the signs may capture data about the user (e.g., via their devices) that could be used for targeted advertising. Additionally or alternatively, the user may be required to watch one or more advertisements in order to join the Wi-Fi network and/or to remain connected to the network after some period of time.

As used herein, a processor, such as the processor(s) 1202 and 1214 may include multiple processors and/or a processor having multiple cores. Further, the processor(s) may comprise one or more cores of different types. For example, the processor(s) may include application processor units, graphic processing units, and so forth. In one implementation, the processor(s)may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

The memory 1204 and/or 1216 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

### EXAMPLE CLAUSES

A: a method comprising: receiving data associated with one or more vehicles within a viewing range of a sign, determining, among the one or more vehicles, a number of autonomously operated vehicles, determining that the number of autonomously operated vehicles exceeds a threshold number, and causing, on the sign, output of content including at least one of: a dynamic image, a changing image, or video data.

B: The method of clause A, further comprising: receiving second data associated with one or more second vehicles within the viewing range of the sign, determining, among the one or more second vehicles, a second number of autonomously operated vehicles, determining that the second number of autonomously operated vehicles exceeds the threshold number, and causing, on the sign, output of second content including at least one of: a static image, a blank image, or at least two sequential images.

C: The method of clause A, further comprising: receiving second data indicating a driver-operated vehicle within the viewing range of the sign, and causing, on the sign, output of second content including at least one of: a static image, a blank image, or at least two sequential images.

D: The method of clause A, wherein the data is associated with at least one of: image data representing the one or more vehicles, sensor data representing light emitted by one or more sensors of the one or more vehicles, or sensor data representing sound being emitted by one or more sensors of the one or more vehicles.

E: The method of clause A, further comprising: receiving second data indicating a driver-operated vehicle within the viewing range of the sign, determining an adjustment to make to the sign, and causing the sign to adjust according to the adjustment.

F: The method of clause A or E, wherein the adjustment comprises at least one of: adjusting a height of the sign, or adjusting an orientation of the sign.

G: The method of clause A or E, wherein the adjustment comprises at least one of: a first position associated with a first height of the sign relative to the vehicle, and a second position associated with a second height of the sign relative to the vehicle, the second height being different than the first height.

H: The method of clause A or G, further comprising: causing output of content on the sign while the sign is in the first position, and refraining from causing output of the content on the sign while the sign is in the second position.

I: A vehicle-mounted system comprising: a sign, and an adjustment mechanism configured to adjust the sign relative to a vehicle to which the sign couples, a sensor, one or more processors, and one or more non-transitory computer-readable media storing computer-executable instructions that, when executed by the one or more processors, cause the one or more processors to perform operations comprising: positioning, by the adjustment mechanism, the sign at a first position, receiving, from the sensor, data indicating a wind load experienced by the sign, determining, based at least in part on the wind load exceeding a threshold amount, to adjust the sign, and positioning, by the adjustment mechanism, the sign at a second position.

J: The vehicle-mounted system of clause I, wherein: the first position is associated with a first height of the sign relative to the vehicle, and the second position is associated with a second height of the sign relative to the vehicle, the second height being different than the first height.

K: The vehicle-mounted system of clause I, the operations further comprising: causing output of content on the sign while the sign is in the first position, and refraining from causing output of the content on the sign while the sign is in the second position.

L: The vehicle-mounted system of clause I, the operations further comprising: receiving, from the sensor, second data indicating a second wind load experienced by the sign, determining, based at least in part on the second wind load being less than the threshold amount, to adjust the sign, and positioning, by the adjustment mechanism, the sign at the first position or a third position.

M: The vehicle-mounted system of clause I, wherein the sensor comprises a first sensor and the data comprises first data, the operations further comprising: receiving, from a second sensor, second data associated with a viewing range of the sign, determining, based at least in part on the second data, a presence of one or more pedestrians within the viewing range, determining a location of the one or more pedestrians, positioning, by the adjustment mechanism and based at least in part on the location, the sign.

N: The vehicle-mounted system of clause I or M, further comprising a second sign, and wherein: the sign is oriented towards a first location in which the one or more pedestrians travel, and the second sign is oriented towards a second location in which vehicles travels.

O: The vehicle-mounted system of clause I, wherein the data comprises first data, the operations further comprising: receiving second data associated with one or more vehicles within a viewing range of the sign, determining, among the one or more vehicles, a number of autonomously operated vehicles, determining that the number of autonomously operated vehicles exceeds a threshold number, and causing, on the sign, output of content including at least one of: a dynamic image, a changing image, or video data.

P: A system comprising: a sign, an adjustment mechanism configured to adjust the sign, a sensor, one or more processors, and one or more non-transitory computer-readable media storing instructions executable by the one or more processors, wherein the instructions, when executed by the one or more processors, cause the one or more processors to perform operations comprising: receiving, from the sensor, data associated with a viewing range of the sign, determining, based at least in part on the data, a presence of one or more pedestrians within the viewing range, determining a location of the one or more pedestrians, positioning, by the adjustment mechanism and based at least in part on the location, the sign, and causing, on the sign, output of content associated with at least one of: a dynamic image, a changing image, or video data.

Q: The system of clause P, further comprising a second sign, and wherein: the sign is oriented towards a first location in which pedestrians travel, and the second sign is oriented towards a second location in which vehicles travels.

R: The system of clause P, wherein the data comprises first data, the operations further comprising: receiving second data associated with one or more vehicles within a viewing range of the sign, determining, among the one or more vehicles, a number of autonomously operated vehicles, determining that the number of autonomously operated vehicles exceeds a threshold number, and causing, on the sign, output of content including at least one of: the dynamic image, the changing image, or the video data.

S: The system of clause P, wherein the sensor comprises a first sensor and the data comprises first data, the operations further comprising: positioning, by the adjustment mechanism, the sign at a first position, receiving, from a second sensor, second data indicating a wind load experienced by the sign, determining, based at least in part on the wind load exceeding a threshold amount, to adjust the sign, and positioning, by the adjustment mechanism, the sign at a second position

T: The system of clause P or S, wherein: the first position is associated with a first height of the sign relative to the vehicle, and the second position is associated with a second height of the sign relative to the vehicle, the second height being different than the first height.

U: A system comprising: one or more processors, and one or more non-transitory computer-readable media storing instructions executable by the one or more processors, wherein the instructions, when executed by the one or more processors, cause the one or more processors to perform operations comprising: receiving first data indicating a first location of a first sign in an environment and first content being output by the first sign, receiving second data indicating a second location of a second sign in the environment and second content being output by the second sign, determining that the first location and the second location are within a threshold location of one another, determining that the first content and the second content are similar, determining third content to be output by the second sign, and transmitting the third content to the second sign.

V: The system of clause U, wherein: the first data is received from the first sign, and the second data is received from the second sign.

X: The system of clause U, wherein at least one of the first sign or the second sign comprises a mobile sign coupled to a vehicle or a trailer.

Y: The system of clause U, the operations further comprising determining, for the second sign, a route along which a vehicle associated with the second sign is to travel.

Z: A system comprising: one or more processors, and one or more non-transitory computer-readable media storing instructions executable by the one or more processors, wherein the instructions, when executed by the one or more processors, cause the one or more processors to perform operations comprising: determining, for a first sign associated with a first geographical area, first content and second content, determining, for a second sign associated with a second geographical area, third content and fourth content, the second geographical area being different than the first geographical area, transmitting, to the first sign, the first content and the second content, and transmitting, to the second sign, the third content and the fourth content.

AA: The system of clause U or Z, the operations further comprising: determining a first route along which a first vehicle associated with the first sign is to travel within the first geographical area, and determining a second route along which a second vehicle associated with the second sign is to travel within the second geographical area.

BB: The system of clause U or Z, the operations further comprising: transmitting, to a third sign within the first geographical area, the third content and the fourth content, and transmitting, to a fourth sign within the second geographical area, the first content and the second content.

CC: The system of clause U or Z, wherein: the first content and the third content comprise static content, and the second content and the fourth content comprises dynamic content.

DD: A system comprising: one or more processors, and one or more non-transitory computer-readable media storing instructions executable by the one or more processors, wherein the instructions, when executed by the one or more processors, cause the one or more processors to perform operations comprising: determining, for a first sign associated with a geographical area, first content and second content, determining, for a second sign associated with the geographical area, third content and fourth content, determining, for the first sign, a first route within the geographical area along which a first vehicle associated with the first sign is to travel, determining, for the second sign, a second route within the geographical area along which a second vehicle associated with the second sign is to travel, transmitting, to the first sign, the first content, the second content, and a first indication of the first route, and transmitting, to the second sign, the third content, the fourth content, and a second indication of the second route.

EE: A method comprising: receiving data associated with one or more vehicles within a viewing range of a sign, determining, among the one or more vehicles, a number of autonomously operated vehicles, determining that the number of autonomously operated vehicles exceeds a threshold number, and causing, on the sign, output of content including at least one of a dynamic image, a changing image, or video data.

FF: The method of clause EE, further comprising: receiving second data associated with one or more second vehicles within the viewing range of the sign, determining, among the one or more second vehicles, a second number of autonomously operated vehicles, determining that the second number of autonomously operated vehicles exceeds the threshold number, and causing, on the sign, output of second content including at least one of: a static image, a blank image, or at least two sequential images.

GG: The method of clause EE, further comprising: receiving second data indicating a driver-operated vehicle within the viewing range of the sign, and causing, on the sign, output of second content including at least one of: a static image, a blank image, or at least two sequential images.

HH: The method of clause EE, wherein the data is associated with at least one of: image data representing the one or more vehicles, sensor data representing light or sound being emitted by one or more sensors of the one or more vehicles.

II: A method comprising: causing content to be display on a sign coupled to an electric vehicle, determining an amount of energy stored in a battery of the electric vehicle, determining that the amount of energy is less than a threshold amount, determining an adjustment to make to the sign, and causing the sign to adjust according to the adjustment.

JJ: The method of clause II, wherein the adjustment comprises at least one of: adjusting a height of the sign, or adjusting an orientation of the sign.

KK: The method of clause II, further comprising determining a route along which the electric vehicle is to travel while the sign is adjusted according to the adjustment.

LL: The method of clause II, further comprising determining a speed at which the electric vehicle is to travel while the sign is adjusted according to the adjustment.

MM: A vehicle-mounted system comprising: a sign, and an adjustment mechanism configured to adjust the sign relative to a vehicle to which the sign couples, a sensor, one or more processors, and one or more non-transitory computer-readable media storing computer-executable instructions that, when executed by the one or more processors, cause the one or more processors to perform operations comprising: positioning, by the adjustment mechanism, the sign at a first position, receiving, from the sensor, data indicating a wind load experienced by the sign, determining, based at least in part on the wind load exceeding a threshold amount, to adjust the sign, and positioning, by the adjustment mechanism, the sign at a second position.

NN: The vehicle-mounted system of clause MM, wherein: the first position is associated with a first height of the sign relative to the vehicle, and the second position is associated with a second height of the sign relative to the vehicle, the second height being different than the first height.

OO: The vehicle-mounted system of clause MM, the operations further comprising: causing output of content on the sign while the sign is in the first position, and refraining from causing output of the content on the sign while the sign is in the second position.

PP: The vehicle-mounted system of clause MM, the operations further comprising: receiving, from the sensor, second data indicating a second wind load experienced by the sign, determining, based at least in part on the second wind load being less than the threshold amount, to adjust the sign, and positioning, by the adjustment mechanism, the sign at the first position or a third position.

QQ: A system comprising: a sign, an adjustment mechanism configured to adjust the sign, a sensor, one or more processors, and one or more non-transitory computer-readable media storing instructions executable by the one or more processors, wherein the instructions, when executed by the one or more processors, cause the one or more processors to perform operations comprising: receiving, from the sensor, data associated with a viewing range of the sign, determining, based at least in part on the data, a presence of one or more pedestrians within the viewing range, determining a location of the one or more pedestrians, positioning, by the adjustment mechanism and based at least in part on the location, the sign, and causing, on the sign, output of content associated with at least one of: a dynamic image, a changing image, or video data.

RR: The system of clause QQ, further comprising a second sign, and wherein: the sign is oriented towards a first location in which pedestrians travel, and the second sign is oriented towards a second location in which vehicles travels.

What is claimed is:

1. A method comprising:
receiving data associated with one or more vehicles within a viewing range of a sign;
determining, among the one or more vehicles, a number of autonomously operated vehicles;
determining that the number of autonomously operated vehicles exceeds a threshold number; and
causing, on the sign, output of content including at least one of:
a dynamic image;
a changing image; or
video data.

2. The method of claim 1, further comprising:
receiving second data associated with one or more second vehicles within the viewing range of the sign;
determining, among the one or more second vehicles, a second number of autonomously operated vehicles;
determining that the second number of autonomously operated vehicles exceeds the threshold number; and
causing, on the sign, output of second content including at least one of:
a static image;
a blank image; or
at least two sequential images.

3. The method of claim 1, further comprising:
receiving second data indicating a driver-operated vehicle within the viewing range of the sign; and
causing, on the sign, output of second content including at least one of:
a static image;
a blank image; or
at least two sequential images.

4. The method of claim 1, wherein the data is associated with at least one of:
image data representing the one or more vehicles;
sensor data representing light emitted by one or more sensors of the one or more vehicles; or
sensor data representing sound being emitted by one or more sensors of the one or more vehicles.

5. The method of claim 1, further comprising:
receiving second data indicating a driver-operated vehicle within the viewing range of the sign;
determining an adjustment to make to the sign; and
causing the sign to adjust according to the adjustment.

6. The method of claim 5, wherein the adjustment comprises at least one of:
adjusting a height of the sign; or
adjusting an orientation of the sign.

7. The method of claim 5, wherein the adjustment comprises at least one of:
a first position associated with a first height of the sign relative to a surface to which the sign is mounted; and
a second position associated with a second height of the sign relative to the surface to which the sign is mounted, the second height being different than the first height.

8. The method of claim 7, further comprising:
causing output of content on the sign while the sign is in the first position; and
refraining from causing output of the content on the sign while the sign is in the second position.

9. A vehicle-mounted system comprising:
a sign;
an adjustment mechanism configured to adjust the sign relative to a vehicle to which the sign couples;
a sensor;
one or more processors; and
one or more non-transitory computer-readable media storing computer-executable instructions that, when executed by the one or more processors, cause the one or more processors to perform operations comprising:
positioning, by the adjustment mechanism, the sign at a first position;
receiving, from the sensor, data indicating a wind load experienced by the sign;
determining, based at least in part on the wind load exceeding a threshold amount, to adjust the sign; and
positioning, by the adjustment mechanism, the sign at a second position.

10. The vehicle-mounted system of claim 9, wherein:
the first position is associated with a first height of the sign relative to the vehicle; and
the second position is associated with a second height of the sign relative to the vehicle, the second height being different than the first height.

11. The vehicle-mounted system of claim 9, the operations further comprising:
causing output of content on the sign while the sign is in the first position; and
refraining from causing output of the content on the sign while the sign is in the second position.

12. The vehicle-mounted system of claim 9, the operations further comprising:
receiving, from the sensor, second data indicating a second wind load experienced by the sign;
determining, based at least in part on the second wind load being less than the threshold amount, to adjust the sign; and
positioning, by the adjustment mechanism, the sign at the first position or a third position.

13. The vehicle-mounted system of claim 9, wherein the sensor comprises a first sensor and the data comprises first data, the operations further comprising:
receiving, from a second sensor, second data associated with a viewing range of the sign;
determining, based at least in part on the second data, a presence of one or more pedestrians within the viewing range;
determining a location of the one or more pedestrians; and
positioning, by the adjustment mechanism and based at least in part on the location, the sign.

14. The vehicle-mounted system of claim 13, further comprising a second sign, and wherein:
the sign is oriented towards a first location in which the one or more pedestrians travel; and
the second sign is oriented towards a second location in which vehicles travels.

15. The vehicle-mounted system of claim 9, wherein the data comprises first data, the operations further comprising:
receiving second data associated with one or more vehicles within a viewing range of the sign;
determining, among the one or more vehicles, a number of autonomously operated vehicles;
determining that the number of autonomously operated vehicles exceeds a threshold number; and
causing, on the sign, output of content including at least one of:
a dynamic image;
a changing image; or
video data.

16. A system comprising:
a sign;
an adjustment mechanism configured to adjust the sign;
a sensor;
one or more processors; and
one or more non-transitory computer-readable media storing instructions executable by the one or more processors, wherein the instructions, when executed by the one or more processors, cause the one or more processors to perform operations comprising:
receiving, from the sensor, data associated with a viewing range of the sign;
determining, based at least in part on the data, a presence of one or more pedestrians within the viewing range;
determining a location of the one or more pedestrians;
positioning, by the adjustment mechanism and based at least in part on the location, the sign; and
causing, on the sign, output of content associated with at least one of:
a dynamic image;
a changing image; or
video data.

17. The system of claim 16, further comprising a second sign, and wherein:
the sign is oriented towards a first location in which pedestrians travel; and
the second sign is oriented towards a second location in which vehicles travels.

18. The system of claim 16, wherein the data comprises first data, the operations further comprising:
receiving second data associated with one or more vehicles within a viewing range of the sign;
determining, among the one or more vehicles, a number of autonomously operated vehicles;
determining that the number of autonomously operated vehicles exceeds a threshold number; and
causing, on the sign, output of content including at least one of:
the dynamic image;
the changing image; or
the video data.

19. The system of claim 16, wherein the sensor comprises a first sensor and the data comprises first data, the operations further comprising:
positioning, by the adjustment mechanism, the sign at a first position;
receiving, from a second sensor, second data indicating a wind load experienced by the sign;
determining, based at least in part on the wind load exceeding a threshold amount, to adjust the sign; and
positioning, by the adjustment mechanism, the sign at a second position.

20. The system of claim 19, wherein:
the first position is associated with a first height of the sign relative to the vehicle; and
the second position is associated with a second height of the sign relative to the vehicle, the second height being different than the first height.
